(19) United States
(12) Patent Application Publication
(10) Pub. No.: US 2008/0320471 A1
(43) Pub. Date: Dec. 25, 2008

(54) System-Program Download System

(75) Inventor: Miyuki Maeda, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Tokyo (JP)

(21) Appl. No.: 11/660,318

(22) PCT Filed: Mar. 23, 2006
(86) PCT No.: PCT/JP2006/305858

§ 371 Date: Feb. 15, 2007

(51) Int. Cl. G06F 9/445

(52) U.S. Cl. 717/178

(57) ABSTRACT

To provide a system-program download system that cannot provide a program for control devices to devices and to persons other than a registered control device and a registered user. The system-program download system includes: a management server that manages information on a customer who has purchased a control device and information on the control device, determines whether a customer and a control device are legitimate upon reception of a request for downloading a program from the customer, and generates a download module including a program and a machine-information verification code that identifies the control device; a portable storage medium 51 that stores a download module received from the management server; and a control device that reads a download module from the portable storage medium 51, and installs the program when the machine-information verification code matches the machine-specific information held by the control device.

### TECHNICAL FIELD

The present invention relates to a system-program download system that prevents an unauthorized use of a program for operating a control device of a processing machine including an electric discharge machine, and a laser beam machine.

### BACKGROUND ART

A control device of an electric discharge machine, a laser beam machine, or the like that performs a process based on a program is operable only after the program is installed on the control device. Such a program has been provided after recorded on a recording medium such as a floppy (registered trademark) disk and a CD (Compact Disk)-ROM (Read Only Memory). Therefore, when a user purchases a plurality of control devices and installs a program stored in one recording medium on these control devices, the user can illegally use the program on the control devices. To prevent such an unauthorized use of a program, a method has been proposed in which a program is downloaded to only a purchaser (hereinafter, “user”) of a control device who is registered (hereinafter, “user registration”) on a network such as the Internet.

On the other hand, apart from the control device, a machine has been proposed that has an antitheft function for preventing a substantial theft of the machine by disabling the operation of the machine when the machine is stolen (for example, see Patent Document 1). The machine with an antitheft function includes a security device having an authenticated mechanism that makes the other party authenticate itself, an authentication mechanism that determines whether the security device is authentic by an authentication process with the authenticated mechanism, and outputs an operation permission signal only when the authentication succeeds, and a machine body that is operative only when receiving the operation permission signal. Accordingly, even when the machine is stolen, a person who has stolen the machine cannot operate the machine unless the upstream security device, to which the machine is connected, authenticates the machine.

Patent Document 1: Patent Publication No. 3600469

### DISCLOSURE OF INVENTION

### Problem to be Solved by the Invention

However, when the machine having an antitheft function described in the above Patent Document 1 is applied to prevent an unauthorized use of the control device, if a registered number of the control device is input to the control device to be illegally used, the control device is authenticated, which allows the control device to be operable. Consequently, a program can be downloaded. As a result, the program and the control device can be illegally used, similarly to when the program is provided in a recording medium.

It is therefore an object of the present invention to provide a system-program download system that allows a person and a control device of an electric discharge machine, a laser beam machine or the like to obtain a device control program only when they have been registered.

### Means for Solving Problem

To overcome the above problems and achieves the object mentioned above, according to the present invention, a system-program download system includes a control device that controls an object to be controlled based on a computer program, a management server that manages the control device, specific information held by the control device, personal information of a customer of the control device, and a program to be installed on the control device, and a customer terminal that is owned by the customer and is connected to the management server via a network and is capable of reading information stored in a portable storage medium. The management server includes a storage unit that stores customer information on a customer including customer identification information that identifies a customer and a contact address of the customer, machine information on a control device including a unique machine number that identifies the control device associated with the customer identification information, and download file information indicating a program to be used in the control device, an input-information checking unit that checks whether customer identification information and a unique machine number contained in input information from the customer terminal are included in the customer information and the machine information in the storage unit, respectively, a password creating unit that creates a password and transmits the password to the contact address in the customer information in the storage unit when the input-information checking unit has verified the input information, a password checking unit that compares a password from the customer terminal with the password created by the password generating unit, and determines whether the customer has a valid control device, a machine-information-verification-code encrypting unit that encrypts the unique machine number contained in the machine information into a machine-information verification code when the password checking unit determines that the customer is legitimate, and a download module controller that generates a download module to be downloaded to the customer terminal from the machine-information verification code and a program corresponding to the unique machine number selected from the download file information contained in the storage medium, and transmits the download module to the customer terminal via the network. The portable storage medium is associated with the control device in one-to-one correspondence, and includes an area that stores a unique machine number of the control device, and an area that stores the download module. The control device includes a storage-medium checking unit that checks whether the unique machine number stored in the portable storage medium matches the unique machine number of the control device when the portable storage medium is set, a download-module analyzing unit that reads the download module stored in the portable storage medium when the unique machine number stored in the portable storage medium matches that of the control device, and a system update controller that performs a process of installing the program contained in the download module.

### EFFECT OF THE INVENTION

According to the present invention, as a first check, when a customer downloads a program for a control device, it is determined whether customer identification information and a unique machine number of the control device match registered information. Further, a password is transmitted to a contact address of the registered customer to make the customer input the password. It is thereby determined whether the customer is legitimate and the control device is valid. As a second check, at the time of installing the program, it is determined whether an encrypted machine-information verification code in a program module matches machine-specific information stored in the control device. Only when these checks complete without problems, the program can be installed on the control device. Therefore, an unauthorized use of the downloaded program, such as unauthorized sharing of the program, can be prevented.

### BRIEF DESCRIPTION OF DRAWINGS

FIG. 1 is a schematic block diagram of a configuration of a system-program download system according to a first embodiment of the present invention.

FIG. 2 is a schematic of a configuration of a storage area of a portable storage device.

FIG. 3 is a flowchart of one example of a program download process.

FIG. 4-1 is a schematic for explaining one example of creation of a machine verification code.

FIG. 4-2 is one example of a list of files that can be downloaded displayed on a screen.

FIG. 4-3 is a schematic for explaining one example of creation of a download module.

FIG. 5 is a flowchart of one example of a program installation process on a control device.

FIG. 6 is a flowchart of one example of a storage-medium verification process.

### EXPLANATIONS OF LETTERS OR NUMERALS

10 Management server
11 Customer-information storage unit
12, 34 Machine-information storage unit
13 Download-file storing unit
14 Communication unit
15 Input-information checking unit
16 Onetime-password generating unit
17 Onetime-password checking unit
18 Machine-information-verification-code encrypting unit
19 Permission-code generating unit
20 Download module controller
21, 39 Controller
30 Control device
31 Storage-medium checking unit
32 Download-module analyzing unit
33 Machine-information-verification-code decoding unit
35 Machine-information checking unit
36 Permission-code storage unit
37 Operation permission controller
38 System update controller
39 System software controller
50 Customer terminal
51 Portable storage medium

### BEST MODE(S) FOR CARRYING OUT THE INVENTION

Exemplary embodiments of a system-program download system according to the present invention are explained in detail below with reference to the accompanying drawings. Note that the invention is not limited to the embodiments.

### FIRST EMBODIMENT

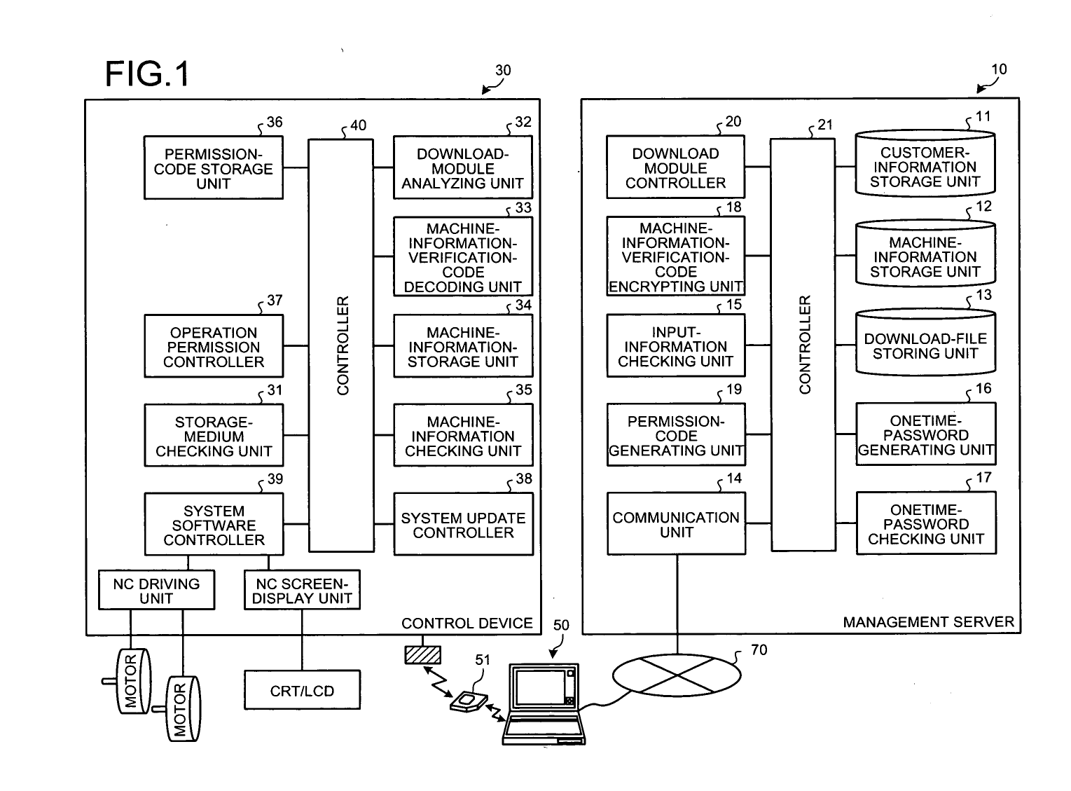

FIG. 1 is a schematic block diagram of a configuration of a system-program download system according to a first embodiment of the present invention. The system-program download system includes a control device 30 that is connected to a machine to be controlled such as an electric discharge machine and a laser beam machine and controls the machine, a management server 10 that manages the control device 30, and a customer terminal 50 such as a personal computer that is owned by a purchaser or an installer (hereinafter, “customer”) of the control device 30. The management server 10 and the customer terminal 50 are connected to each other by a network 70 such as the Internet or a dedicated line.

The management server 10 includes a customer-information storage unit 11, a machine-information storage unit 12, a download-file storing unit 13, a communication unit 14, an input-information checking unit 15, a onetime-password generating unit 16, a onetime-password checking unit 17, a machine-information-verification-code encrypting unit 18, a permission-code generating unit 19, a download module controller 20, and a controller 21 that controls these processing units.

The customer-information storage unit 11 stores therein customer information necessary to manage a customer who has purchased the control device 30. The customer information includes a customer name, a contact address such as an email address, and customer identification information for identifying a customer.

The machine-information storage unit 12 stores therein machine information including a unique machine number assigned to the control device 30 to identify the control device 30, a type of the control device 30, and customer identification information of a customer who has purchased the control device 30 having the unique machine number. The customer identification information associates the control device 30 with a customer who has purchased the control device 30. The machine information can further include a date of purchase of the control device 30 to determine a test period of the control device 30 using an operation permission code. After the control device 30 is delivered to the customer, a service person who sets the control device 30 or a sales representative of a manufacturer of the control device 30 confirms the customer information, and inputs the machine information of the actually delivered control device 30 (machine type, optional function, actual delivery date, etc.) to the machine-information storage unit 12.

The download-file storing unit 13 stores therein download files including a file of a program to be installed on the control device 30 and that indicating an operation method. These download files are managed according to the type of the control device 30. The customer-information storage unit 11, the machine-information storage unit 12, and the download-file storing unit 13 correspond to a storage unit in claims.

The communication unit 14 has a function of communicating with the customer terminal 50 via the network 70. For example, when a customer downloads a program, the communication unit 14 receives information that identifies the customer and input information including a unique machine number transmitted from the customer terminal 50. The communication unit 14 also transmits authentication email including a onetime password to the customer terminal 50 to authenticate the customer, and receives a onetime password from the customer terminal 50.

The input-information checking unit 15 determines whether the content of input information received from the customer terminal 50 through the communication unit 14 is registered in the customer-information storage unit 11 and the machine-information storage unit 12, and authenticates whether a transmitter of the input information is a legitimate customer. The input information includes a customer name, customer identification information, and a unique machine number. When the content of the input information matches that registered in the customer-information storage unit 11 and the machine-information storage unit 12, the input-information checking unit 15 preliminarily determines that the customer that has transmitted the input information is a reliable customer, and outputs a result of the authentication to the onetime-password generating unit 16 to perform the next authentication. On the other hand, when the content of the input information does not match that registered in the customer-information storage unit 11 and the machine-information storage unit 12, the input-information checking unit 15 determines that the customer who has transmitted the input information is not a legitimate customer, and notifies the customer terminal 50 of the unsuccessful authentication via the communication unit 14. The input-information checking unit 15 corresponds to an input-information checking unit in claims.

The onetime-password generating unit 16 generates a onetime password when the input-information checking unit 15 preliminarily determines that the transmitter of the input information is a reliable customer, and transmits the onetime password to an email address (contact address) of the customer stored in the customer-information storage unit 11 via the communication unit 14. The onetime-password generating unit 16 also sends the generated onetime password to the onetime-password checking unit 17 in association with the customer identification information. The onetime-password generating unit 16 corresponds to a password generating unit in claims.

The onetime-password checking unit 17 checks whether the onetime password is correct upon receiving a onetime password via the communication unit 14. A unique machine number need not be input at the same time the onetime password is input, and only customer identification information necessary to access the management server 10 needs to be input. When the onetime password received from the customer terminal 50 is correct, the onetime-password checking unit 17 determines that the customer is legitimate, and outputs a result of the determination to the machine-information-verification-code encrypting unit 18, the permission-code generating unit 19, and the download module controller 20. The onetime-password checking unit 17 corresponds to a password checking unit in claims.

The machine-information-verification-code encrypting unit 18 encrypts, when a customer is going to download a program into the control device 30, a machine-information verification code that determines whether the customer is installing the program on the legitimately-purchased control device 30. The machine-information verification code that is encrypted this time is generated from machine information, including a unique machine number and a type of the control device 30, stored in the machine-information storage unit 12 of the management server 10. Specifically, when the onetime-password checking unit 17 determines that the customer is legitimate, the machine-information-verification-code encrypting unit 18 extracts, as a machine-information verification code, the unique machine number and the type of the control device 30 from the machine-information storage unit 12 based on the unique machine number input by the customer, and encrypts the machine-information verification code. The encryption is performed using a predetermined encryption algorithm. The encrypted machine-information verification code is sent to the download module controller 20. The machine-information-verification-code encrypting unit 18 corresponds to a machine-information verification code encrypting unit in claims.

The permission-code generating unit 19 generates an operation permission code that permits the control device 30 to operate when the onetime-password checking unit 17 determines the customer as a legitimate customer. For example, when a usable period of the control device 30 has been determined (e.g., three years, one year, or three months) between the manufacturer and the customer, the operation permission code includes a code that permits the operation of the control device 30 during the usable period, and otherwise does not permit the operation of the control device 30. In this case, the purchase date of the control device 30 in the machine information is used. The permission-code generating unit 19 corresponds to a permission-code generating unit in claims.

The download module controller 20 transmits a download module to the customer terminal 50 via the communication unit 14 when the onetime-password checking unit 17 determines that a transmitter of input information is a legitimate customer. The download module includes a program relevant to the control device 30 included in the input information obtained from the download-file storing unit 13, and a machine-information verification code from the machine-information-verification-code encrypting unit 18. To transmit the download module, a known file transfer process method, such as HTTP (Hypertext Transfer Protocol) and FTP (File Transfer Protocol), can be used. A download module can be transmitted, as an attached file, to a customer's email address stored in the customer-information storage unit 11. The program and the machine-information verification code can be compressed to be transmitted as one download file. The download module controller 20 corresponds to a download module controller in claims.

The control device 30 includes a storage-medium checking unit 31, a download-module analyzing unit 32, a machine-information-verification-code decoding unit 33, a machine-information storage unit 34, a machine-information checking unit 35, a permission-code storage unit 36, an operation permission controller 36, a system update controller 38, a system software controller 39, and a controller 40 that controls these processing units.

The storage-medium checking unit 31 checks, when a portable storage medium 51 that stores a download module is set in the control device 30, whether a unique machine number in a private area of the portable storage medium 51 matches that in the machine-information storage unit 34. Only when both unique machine numbers match each other, the storage-medium checking unit 31 loads the download module into the control device 30. For example, the storage-medium checking unit 31 can copy the download module in the portable storage medium 51 into a storage unit (not shown) such as a hard disk drive (not shown) in the control device 30, or can keep the download module in the portable storage medium 51. The storage-medium checking unit 31 corresponds to a storage-medium checking unit in claims.

The download-module analyzing unit 32 reads a download module downloaded in the portable storage medium 51, or reads a download module copied in a storage unit (not shown) from the portable storage medium 51, and sends respective files that constitute the download module to a predetermined processing unit. Specifically, the machine-information verification code is sent to the machine-information-verification-code decoding unit 33, and the program is sent to the system update controller 38. When the program and the machine-information verification code are compressed into one file, the download-module analyzing unit 32 uncompresses the file, and sends the uncompressed file to each of the processing units. The download-module analyzing unit 32 corresponds to a download-module analyzing unit in claims.

The machine-information-verification-code decoding unit 33 decodes a machine-information verification code received from the download-module analyzing unit 32, and sends the decoded machine-information verification code to the machine-information checking unit 35. In this case, an algorithm used for the decoding corresponds to the encryption algorithm used in the management server 10.

The machine-information storage unit 34 stores therein a unique machine number assigned as a specific identification number to the control device 30. The unique machine number is stored in the machine-information storage unit 12 of the management server 10. A manufacturer of the control device inputs the machine information to the machine-information storage unit 34 before shipment.

The machine-information checking unit 35 checks whether a machine-information verification code decoded by the machine-information-verification-code decoding unit 33 matches a unique machine number stored in the machine-information storage unit 34 to determine whether a download module is valid to be used in the control device 30. The machine-information checking unit 35 sends a result of the determination to the system software controller 39. The machine-information-verification-code decoding unit 33 and the machine-information checking unit 35 correspond to a machine-information checking unit in claims.

The permission-code storage unit 36 stores an operation permission code downloaded from the management server 10 and retrieved from the portable storage medium 51. The operation permission controller 36 refers to an operation permission code stored in the permission-code storage unit 36, and determines whether the control device 30 is in an operable state. When the control device 30 is in the operable state, the permission-code storage unit 36 permits the system software controller 39 to execute the program. The permission-code storage unit 36 corresponds to a permission code storage unit in claims.

The system update controller 38 installs a file (program) sent from the download-module analyzing unit 32 on the control device 30 so that the file can be executed when the machine-information checking unit 35 determines the download module is valid. The system update controller 38 corresponds to a system update controller in claims.

The system software controller 39 controls, for example, an NC driving unit and an NC screen-display unit. Specifically, when the machine-information checking unit 35 determines that a machine-information verification code matches a unique machine number stored in the machine-information storage unit 34, and also when the operation permission controller 36 permits the operation after the system update controller 38 completes the installation of a program, the system software controller 39 controls, according to the program, the NC driving unit to perform a process on an electric discharge machine, a laser beam machine or the like, or controls the NC screen-display unit to display predetermined information on a display unit such as a CRT (Cathode Ray Tube) and an LCD (Liquid Crystal Display).

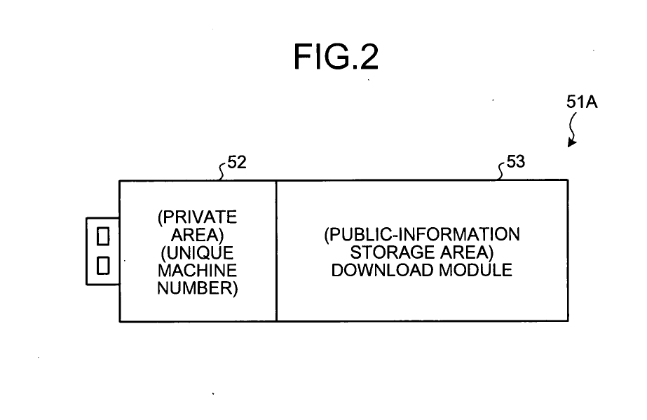

The customer terminal 50 is an information processing device such as a general personal computer, and includes a communication unit capable of communication using HTTP (Hyper Text Transport Protocol) and exchanging email with the management server 10 through the network 70, a display unit, and an input unit. Any device can be used as the customer terminal 50 as long as it can read information stored in the portable storage medium 51 that stores download files from the management server 10. In the first embodiment, a memory card, a USB (Universal Serial Bus) memory, or the like is used as the portable storage medium 51. FIG. 2 is a schematic of a configuration of a storage area of the portable storage device. The portable storage medium 51A is prepared for each control device 30. The storage area includes a private area 52 that a general user (customer) cannot access, and a public-information storage area 53 where general data can be read and written. A unique machine number of the corresponding control device 30 is written in advance to the private area 52. The public-information storage area stores a download module downloaded from the management server 10.

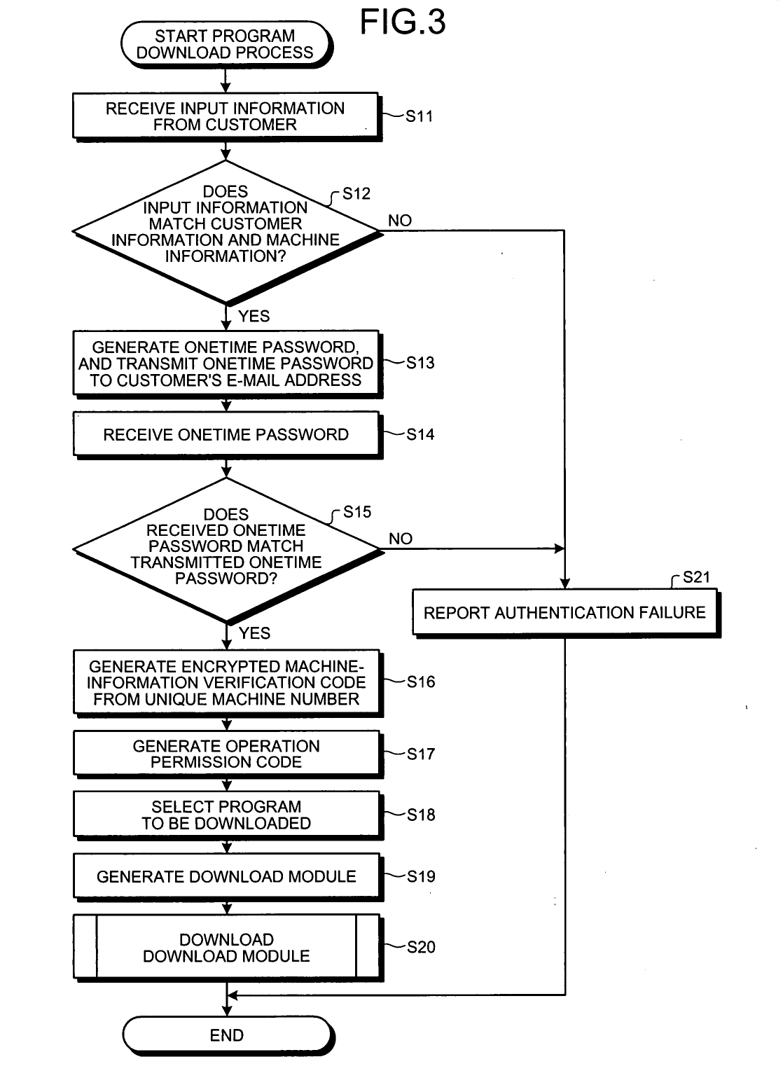

A program download process and a program installation process in the system-program download system having the above configuration are explained next. FIG. 3 is a flowchart of one example of the program download process. First, a customer connects the customer terminal 50 to the management server 10 via the network 70, and inputs personal information and machine information. For example, the customer accesses a website managed by the management server 10 to display an input screen for inputting personal information and machine information, and inputs information including personal information of the customer and information on a machine that the customer purchased. The input information can be a customer name, customer identification information, and a unique machine number, for example. The customer transmits the input information to the management server 10.

When the communication unit 14 of the management server 10 receives input information from the customer (step S11), the input-information checking unit 15 determines whether the input information of the customer matches the content of customer information and machine information stored in the customer-information storage unit 11 and the machine-information storage unit 12, respectively (step S12). When the input-information checking unit 15 determines that the input information matches the customer information and the machine information (Yes at step S12), the onetime-password generating unit 16 generates a onetime password that is valid only once and during only a predetermined period since the generation thereof. The onetime-password generating unit 16 extracts an email address corresponding to the customer identification information included in the input information from the customer-information storage unit 11, and transmits the generated onetime password to the email address through the communication unit 14 (step S13). At this time, the onetime-password generating unit 16 sends the generated password in association with the customer identification information (or the contact address of the customer such as the customer's email address) to the onetime-password checking unit 17.

Thereafter, when the email containing the onetime password reaches the email address of the customer, the customer transmits the onetime password to the management server 10. For example, the customer accesses the website managed by the management server 10, thereby displaying a onetime-password input screen to input the customer identification information (or the customer's email address) and the onetime password. The customer inputs the customer identification information (or the customer's email address) and the onetime password through the input screen, and transmits the input information.

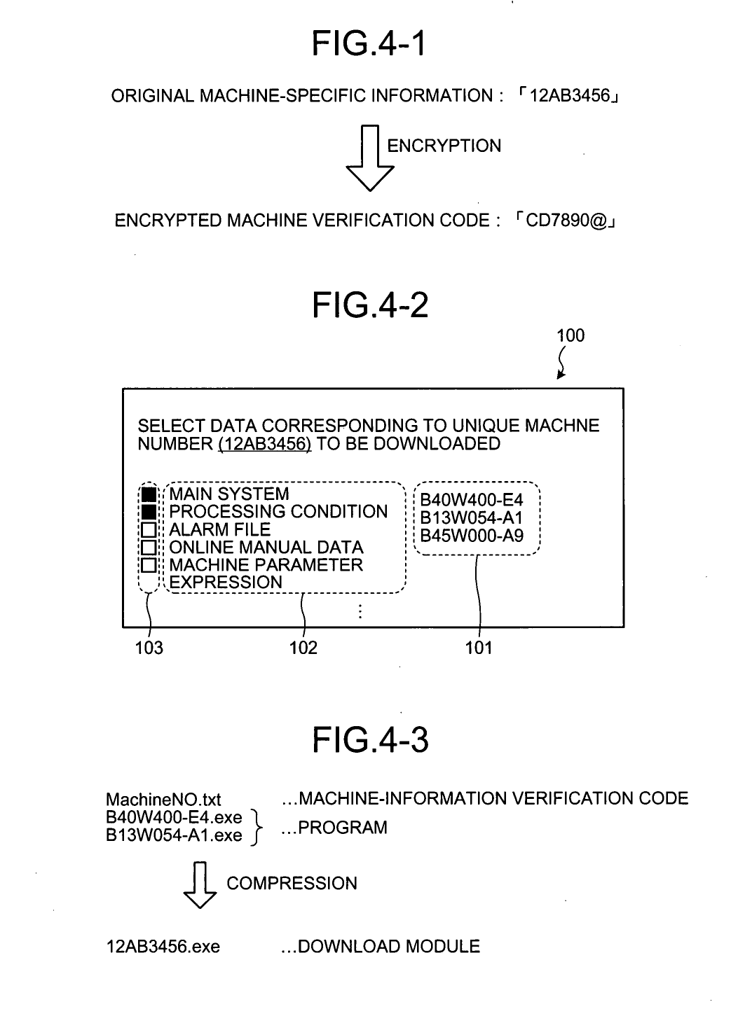

When the communication unit 14 of the management server 10 receives the customer identification information (or the customer's email address) and the onetime password from the customer (step S14), the onetime-password checking unit 17 determines whether the onetime password received from the customer matches the one that the onetime-password generating unit 16 has transmitted to the customer (step S15). When the onetime-password checking unit 17 determines that the received onetime password matches the generated (transmitted) onetime password (Yes at step S15), the machine-information-verification-code encrypting unit 18 obtains from the machine-information storage unit 12 a unique machine number corresponding to the input information received at step S11 as a machine-information verification code, and encrypts the machine-information verification code (step S16). FIG. 4-1 is a schematic for explaining one example of creation of a machine verification code. As shown in the drawing, original machine-specific information “12AB3456” is converted into, for example, a machine verification code “CD7890@” according to a predetermined encryption algorithm. The permission-code generating unit 19 generates an operation permission code for permitting the operation of the control machine on which the program is to be installed (step S17).

Thereafter, the download module controller 20 selects a program to be downloaded by the customer from the download-file storing unit 13 based on the machine information included in the input information (step S18). In this case, the download module controller 20 can presents a list of programs (files) available for download to the customer terminal 50. FIG. 4-2 is one example of a list of downloadable files displayed on a screen. A display screen 100 displays items including a name 101 of data containing files of downloadable programs or manuals corresponding to the machine information (unique machine number) in the input information received from the customer at step S11, a description 102 of data indicating brief content of the data, and a check box 103 indicating selected data. For example, the customer clicks the check box 103 of data in the list which the customer wishes to download (in the drawing, black boxes are selected) on the customer terminal 50, and transmits the screen contents to the management server 10. In this case, the data in the download-file storing unit 13 is stored in association with the control device 30 in which the program is to be used.

The download module controller 20 generates a download module from a collection of the selected program, the encrypted machine-information verification code generated at step S16, and the operation permission code generated at step S17 (step S19). As described above, the program, the machine-information verification code, and the operation permission code can be collected together into a compressed file as the download module. FIG. 4-3 is a schematic for explaining one example of creation of a download module. A file “MachineNO.txt” to which the machine-information verification code encrypted in FIG. 4-1 is written, and files “B40W400-E4.exe” and “B13W054-A1.exe” that are the data selected in FIG. 4-2 are compressed together into one file (converted into a download module) “12AB3456.exe”. Then, the download module is downloaded to the public-information storage area 53 of the portable storage medium 51 (step S20), and the program download process ends.

On the other hand, when the input-information checking unit 15 determines that the input information does not match the customer information and the machine information (No at step S12), the input-information checking unit 15 notifies the customer terminal 50 of an authentication failure (step S21), and the process ends. When the onetime-password checking unit 17 determines that the received onetime password does not match the generated (transmitted) onetime password (No at step S15), the onetime-password checking unit 17 notifies the customer terminal 50 of an authentication failure (step S21), and the process ends.

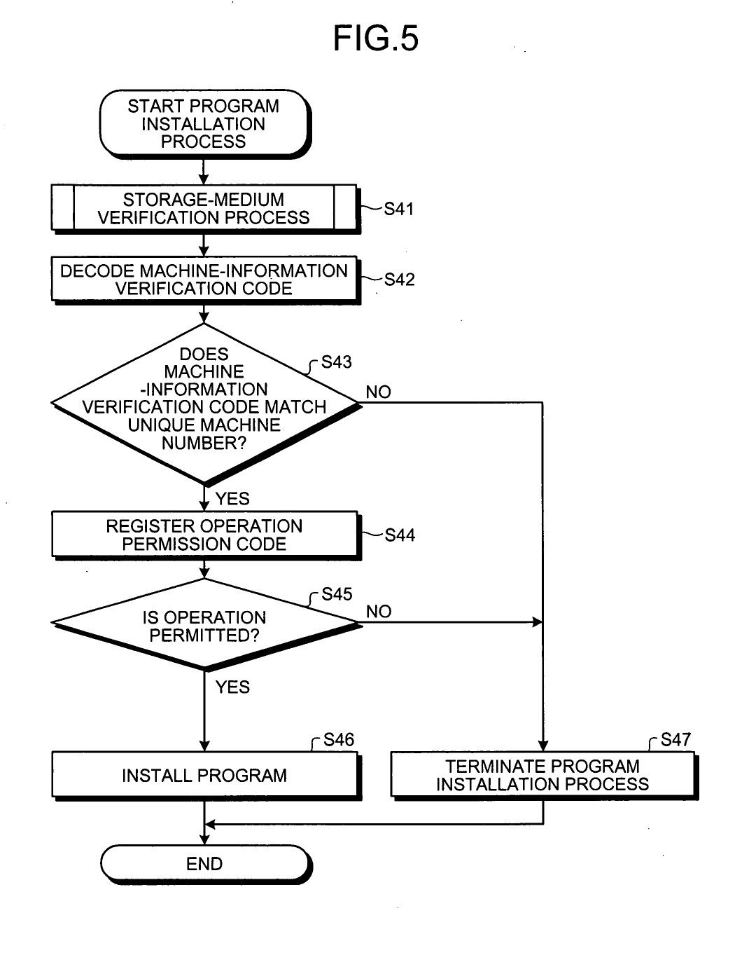

FIG. 5 is a flowchart of one example of the program installation process on the control device. To install a program on the control device 30, the portable storage medium 51 to which the program has been downloaded in the process shown in FIG. 3 is connected to (set in) the control device 30. Thereafter, when a menu for updating the system of the control device 30 is selected on the screen (not shown) of the control device 30, the process shown in the flowchart of FIG. 5 is performed.

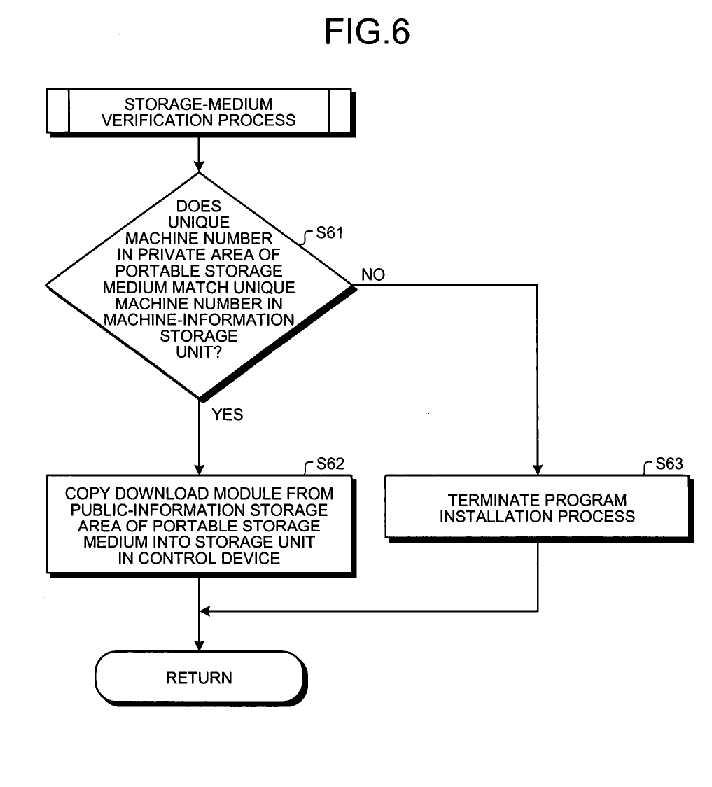

First, the storage-medium checking unit 31 performs a storage-medium verification process (step S41). FIG. 6 is a flowchart of one example of the storage-medium verification process. As shown in FIG. 6, the storage-medium checking unit 31 determines whether a unique machine number in the private area 52 of the portable storage medium 51 matches that in the machine-information storage unit 34 (step S61). When the unique machine number in the private area 52 of the portable storage medium 51 in the customer terminal 50 matches that in the machine-information storage unit 34 (Yes step S61), the system update controller 38 copies the download module from the public-information storage area 53 of the portable storage medium 51 to the storage unit such as a hard disk drive or the like (not shown) in the control device 30 (step S62). When the download module has been compressed, the system update controller 38 decompresses the download module into files of a program, a machine-information verification code, and an operation permission code. The download-module analyzing unit 32 sends each file in the download module to a predetermined processing unit. On the other hand, when the unique machine number in the private area 52 of the portable storage medium 51 does not match that in the machine-information storage unit 34 (No at step S61), the system update controller 38 terminates the program installation process, and indicates this information on a screen (not shown). The process returns to the flowchart shown in FIG. 5.

The machine-information-verification-code decoding unit 33 decodes the machine-information verification code from the copied download module according to a predetermined algorithm (step S42). Thereafter, the machine-information checking unit 35 checks whether the machine-information verification code decoded by the machine-information-verification-code decoding unit 33 matches the unique machine number stored in the machine-information storage unit 34 (step S43). When the machine-information verification code matches the unique machine number (Yes at step S63), the download-module analyzing unit 32 registers the operation permission code in the permission-code storage unit 36 (step S44). The operation permission controller 36 controller 37 reads the operation permission code registered in the permission-code storage unit 36, and checks whether the operation is permitted (step S45). For example, when an operable period has been set as the operation permission code, the operation permission controller 37 determines that the operation is permitted if during the operable period. When the operation is permitted (Yes at step S45), the system update controller 38 performs the process of installing the program on a storage unit such as a ROM and a hard disk drive (not shown) in the control device 30 (step S46). For example, the system update controller 38 sequentially analyzes the decompressed download module, and registers the decompressed download module in a corresponding drive or folder (directory) of a hard disk of the control device 30. Then, the program installation process ends.

When the machine-information verification code does not match the unique machine number (No at step S43) or when the operation is not permitted at step S45 (No at step S45), the program installation process is terminated (step S47). Thus, the program installation process ends.

When the program installation process ends, the system software controller 39 reads the installed program, and performs the process according to the program. Incidentally, when the program installation process ends, the control device 30 is usually restarted. Also in this case, before the system software controller 39 executes the program, the operation permission controller 36 refers to the value of the operation permission code in the permission-code storage unit 36, and determines whether the program processing is possible. If possible, the system software controller 39 performs the process.

In the above explanation, the management server 10 includes the permission-code generating unit 19, and the control device 30 includes the permission-code storage unit 36 and the operation permission controller 36. A determination as to the installation of a program on the control device 30 is determined based on the presence or absence of the operation permission code. However, the operation permission code is not necessarily used.

In the above explanation, the permission-code storage unit 36 of the control device 30 stores the permission code downloaded from the management server 10. Upon activating the control device 30, the permission code is read to determine whether the control device 30 can operate. For example, when the operation permission code is set such that the control device 30 can operate during only a predetermined period since the purchase date of the control device 30, the control device 30 cannot operate after the operable period has passed. Therefore, to maintain the control device 30 operable, only the permission code can be obtained. In this case, the permission code and the machine verification code are downloaded, in a similar manner to that of downloading the program described above. The permission code is then written to the permission-code storage unit 36 of the control device 30.

A download module can be downloaded to each of a plurality of the control devices 30. In this case, the process at steps S16 to S19 in the flowchart of FIG. 3 is repeated. Thereafter, download modules are downloaded all at once to the storage unit such as a hard disk drive of the customer terminal 50 at step S20. The downloaded modules are allocated to the portable storage mediums 51 corresponding to the control devices 30 from the storage unit of the customer terminal 50, and the downloaded modules are registered.

In the above explanation, the management server 10 and the customer terminal 50 are connected to the network 70, and the portable storage medium 51 that stores the download module from the management server 10 is set in the control device 30 to install the program on the control device 30. When, however, the control device 30 is directly connected to the network 70, the program can be directly downloaded from the management server 10 to the storage device of the control device 30. In this case, the private area 52 is provided in the storage device of the control device 30. Then, in a similar manner as explained above, machine-specific information that identifies the control device 30 is stored in the private area 52 so that it can be determined whether the valid control device 30 is about to download the program. When customer identification information as well as the machine-specific information is stored in the private area 52, the program can be downloaded in a stricter manner.

The system-program download system explained above is not only effective to update the version of a program to be run on the control device 30, but is also effective to version down the program to the last one. In this case, at step S18 in FIG. 3, the management server 10 causes the customer terminal 50 to display all programs (files) created for the machine-specific information so that a program in the last version can be selected.

According to the first embodiment, as a first check, when a customer downloads a program for the control device 30, it is determined whether the customer identification information and the unique machine number of the control device 30 match registered information. Additionally, a onetime password is transmitted to a contact address of the registered customer to make the customer input the onetime password. It is thereby determined whether the customer is legitimate and the control device 30 is valid. As a second check, it is determined whether the portable storage medium 51 that stores a program module including the program is the one manufactured for the control device 30 with the registered unique machine number. As a third check, when the program is installed, it is determined whether an encrypted machine-information verification code in the program module matches machine-specific information stored in the control device 30. Only when these checks complete without problems, the program can be installed on the control device 30. Therefore, an unauthorized use of the downloaded program, such as unauthorized sharing of the program, can be prevented.

A malfunction of the control device due to an erroneous registration of a system can be also prevented. For example, because the management server 10 can properly display modules suitable for the control device 30 as options based on the machine-specific information, the customer can avoid selecting a wrong module. After downloading the program, when the portable storage medium 51 is set in the wrong control device 30, an error occurs. Therefore, a wrong system cannot be registered. Particularly, when the customer possesses a plurality of the control devices 30 and there are a large number of floppy (registered trademark) disks that store system programs, it has been difficult to recognize which one of the floppy disks corresponds to which one of the control devices 30. As a result, there has been a risk that a system program and a parameter for a certain control device are registered in another control device, which results in a malfunction. However, with the system-program download system of the first embodiment, such malfunction can be prevented. Further, in the case of updating a system program and charging the customer for the system program in the updated version, the issuance of an operation permission code prevents the customer from using the updated system program for free of charge.

### SECOND EMBODIMENT

In the first embodiment, when a customer (=a purchaser) and the purchased control device 30 match registered information, a program can be downloaded and installed on the control device 30. However, actually, a customer who has purchased the control device 30 does not assemble (install) the control device 30, in many cases, and other system designer (hereinafter, “service person”) installs the control device 30. In this case, according to the first embodiment, the program cannot be installed on the control device 30. In a second embodiment, a system-program download system is explained that allows even a person (service person) other than a customer to download and install a program on the control device 30.

In this case, the management server 10 further includes a service-person storage unit that manages service person information including a name of a service person, service-person identification information that identifies the service person, and a contact address of the service person such as an email address. The service-person identification information is associated with the unique machine number of the control device 30 stored in the machine-information storage unit 12.

The input-information checking unit 15 determines whether the input information containing the information concerning the service person indicates a combination of a legitimate service person and the control device 30 based on the service person information and the machine information. The onetime-password generating unit 16 transmits a onetime password to the email address of the service person contained in the service person information. The machine-information-verification-code encrypting unit 18 encrypts the service-person identification information as a unique machine number. The download module controller 20 determines whether to permit downloading of a download module based on the service-person identification information stored in the private area 52 of the portable storage medium 51 owned by the service person.

The machine-information storage unit 34 of the control device 30 also stores the service-person identification information of the service person who has installed the control device in addition to the machine-specific information. The machine-information checking unit 35 compares the decoded machine-information verification code with the service-person identification information in the machine-information storage unit 34, thereby checking the information.

The program download process and program installation process on the control device 30 performed by the service person are the same as previously described in the first embodiment, except that the service-person identification information is used as the unique machine number. Therefore, the same explanation is not repeated.

The second embodiment can achieve the effect, in addition to the effect of the first embodiment, that, even when a service person other than a customer who has purchased the control device 30 has installed the control device 30, the service person can download and install a program to operate the control device 30.

### INDUSTRIAL APPLICABILITY

As described above, the system-program download system according to the present invention is useful to prevent an unauthorized use of a program installed on a control device.

1-8. (canceled)

9. A system-program download system comprising:
a control device that operates according to a computer program;
a management server that manages the control device, and a program to be installed on the control device; and
a user terminal that is connected to the management server via a network, and reads a portable storage medium, wherein
the management server includes
a storage unit that stores therein user information that indicates personal information of a user of the control device including user identification information to identify the user, device information including a device number that identifies the control device associated with the user identification information, and file information indicating at least one program to be used in the control device;
a verifying unit that verifies user identification information and a device number contained in input information from the user terminal based on the user information and the device information;
a password creating unit that creates a password and notifies the user of the password when the input information has been verified;
an authenticating unit that authenticates the user, upon receiving a password from the user terminal, by comparing received password with the password created by the password creating unit;
an encrypting unit that encrypts the device number contained in the device information into a verification code when the user has been authenticated; and
a module creating unit that creates a module to be downloaded to the user terminal, from the verification code and a program corresponding to the device number selected from the file information, and transmits the module to the user terminal via the network,
the portable storage medium is associated with the control device in one-to-one correspondence, and includes an area that stores a device number of the control device, and an area that stores the module, and
the control device includes
a checking unit that checks whether the device number stored in the portable storage medium matches the device number of the control device when the portable storage medium is set in the control device;
a module analyzing unit that reads the module from the portable storage medium when the device numbers match; and an updating unit that installs the program contained in the module on the control device.

10. The system-program download system according to claim 9, wherein
the management server further includes a code generating unit that generates a permission code indicating a condition for allowing the control device to execute the program,
the module creating unit generates the module from the verification code, the program, and the permission code,
the control device further includes
a code storage unit that stores therein the permission code contained in the module; and
a control unit that refers to the permission code, upon activating the control device, to determine whether to executes the program on the control device.

11. The system-program download system according to claim 9, wherein
the control device further includes an information checking unit that decodes the verification code contained in the module, and determines whether the verification code matches the device number of the control device, and
the updating unit installs the program on the control device when the verification code matches the device number.

12. A system-program download system comprising:
a control device that operates according to a computer program;
a management server that manages the control device, and a program to be installed on the control device; and
a user terminal that is connected to the management server via a network, and reads a portable storage medium, wherein
the management server includes
a storage unit that stores therein first information that indicates personal information of a person responsible for managing the control device including identification information to identify the person, second information including a device number that identifies the control device associated with the identification information, and third information indicating at least one program to be used in the control device;
a verifying unit that verifies identification information and a device number contained in input information from the user terminal based on the first and second information;
a password creating unit that creates a password and notifies the person of the password when the input information has been verified;
an authenticating unit that authenticates the person, upon receiving a password from the user terminal, by comparing received password with the password created by the password creating unit;
an encrypting unit that encrypts the identification information contained in the first information into a verification code when the person has been authenticated; and
a module creating unit that creates a module to be downloaded to the user terminal, from the verification code and a program corresponding to the device number selected from the third information, and transmits the module to the user terminal via the network,
the portable storage medium is associated with the control device in one-to-one correspondence, and includes an area that stores a device number of the control device, and an area that stores the module, and
the control device includes
a checking unit that checks whether the device number stored in the portable storage medium matches the device number of the control device when the portable storage medium is set in the control device;
a module analyzing unit that reads the module from the portable storage medium when the device numbers match; and
an updating unit that installs the program contained in the module on the control device.

13. The system-program download system according to claim 12, wherein
the management server further includes a code generating unit that generates a permission code indicating a condition for allowing the control device to execute the program,
the module creating unit generates the module from the verification code, the program, and the permission code,
the control device further includes
a code storage unit that stores therein the permission code contained in the module; and
a control unit that refers to the permission code, upon activating the control device, to determine whether to executes the program on the control device.

14. The system-program download system according to claim 12, wherein
the control device further includes an information checking unit that decodes the verification code contained in the module, and determines whether the verification code matches identification information to identify the person stored therein, and
the updating unit installs the program on the control device when the verification code matches the identification information.

15. A system-program download system comprising:
a control device that operates according to a computer program;
a management server that manages the control device, unique information on the control device, personal information of a user of the control device, and a program to be installed on the control device; and
a user terminal that is connected to the management server via a network, and reads a portable storage medium, wherein the management server includes
a storage unit that stores therein user information including user identification information that identifies the user, device information including a device number that identifies the control device associated with the user identification information, and file information indicating at least one program to be used in the control device;
a verifying unit that verifies user identification information and a device number contained in input information from the user terminal based on the user information and the device information;
a password creating unit that creates a password and notifies the user of the password when the input information has been verified;
an authenticating unit that authenticates the user, upon receiving a password from the user terminal, by comparing received password with the password created by the password creating unit;
an encrypting unit that encrypts the device number contained in the device information into a verification code when the user has been authenticated; and
a module creating unit that creates a module to be downloaded to the user terminal, from the verification code and a program corresponding to the device number selected from the file information, and transmits the module to the user terminal via the network.

16. A system-program download system comprising:
a control device that operates according to a computer program;
a management server that manages the control device, unique information on the control device, personal information of a user of the control device, and a program to be installed on the control device; and
a portable storage medium that is associated with the control device in one-to-one correspondence, and includes an area that stores a device number of the control device, and an area that stores a module downloaded from the management server, wherein
the control device checks whether the device number stored in the portable storage medium matches the device number of the control device when the portable storage medium is set therein, reads the module from the portable storage medium when the device numbers match, decodes a verification code contained in the module to determine whether the verification code matches the device number thereof, and installs the program contained in the module thereon. selected from the file information, and transmits the module to the user terminal via the network.

16. A system-program download system comprising:
a control device that operates according to a computer program;
a management server that manages the control device, unique information on the control device, personal information of a user of the control device, and a program to be installed on the control device; and
a portable storage medium that is associated with the control device in one-to-one correspondence, and includes an area that stores a device number of the control device, and an area that stores a module downloaded from the management server, wherein
the control device checks whether the device number stored in the portable storage medium matches the device number of the control device when the portable storage medium is set therein, reads the module from the portable storage medium when the device numbers match, decodes a verification code contained in the module to determine whether the verification code matches the device number thereof, and installs the program contained in the module thereon.
